(19) United States
(12) Patent Application Publication
(10) Pub. No.: US 2011/0163640 A1
(43) Pub. Date: Jul. 7, 2011

(54) Rotor cooling for a dynamoelectric machine

(76) Inventors: Haiko Adolf, Erfurt (DE); Heinrich Kaluza, Erfurt (DE); Olaf Michelsson, Arnstadt (DE); Johannes Reinold, Castrop-Rauxel (DE)

(21) Appl. No.: 12/310,714

(22) PCT Filed: Aug. 2, 2007
(86) PCT No.: PCT/EP2007/058008

§ 371 Date: Jan. 18, 2011

(30) Foreign Application Priority Data
Mar. 13, 2008 (EP) 06018717.6

(51) Int. Cl. H02K 1/32

(52) U.S. Cl. 310/60 A

(57) ABSTRACT

A rotor for a dynamoelectric machine is disclosed. A bottom duct is disposed in the rotor, through which a cooling medium flows and conductors are cooled via radial ducts during operation. The bottom duct is embodied such that the cross section thereof decreases towards the center of the rotor.

### CROSS REFERENCE TO RELATED APPLICATIONS

This application is the US National Stage of International Application No. PCT/EP2007/058008 filed Aug. 2, 2007 and claims the benefit thereof. The International Application claims the benefits of European Patent application No. 06018717.6 EP filed Sep. 6, 2006, both of the applications are incorporated by reference herein in their entirety.

### FIELD OF INVENTION

The invention relates to a rotor for a dynamoelectric machine, with the rotor having a base channel for cooling of conductors which are arranged on the rotor, with the rotor being designed such that a cooling medium can flow through it during operation.

### SUMMARY OF INVENTION

Inter alia, the expression dynamoelectric machine should be understood as meaning a generator or a motor. The present application preferably relates to generators, although the invention is also applicable to other electrical machines. Generators for communal power supplies have a rating of several hundred MVA. Generators essentially have a rotor and a stator arranged around the rotor. Both the rotor and the stator have conductors through which an electric current flows. These electric currents are comparatively high and cause severe heating of the conductors. The conductors, particularly in the rotor, must therefore be cooled. Essentially two cooling media are used for this purpose. By way of example, hydrogen or water may be used as a cooling medium.

The electrical conductors in the rotors are embedded in so-called slots, with a base channel being formed between the electrical conductor and the rotor base body. According to the prior art, this base channel is in the form of a channel with a constant cross section.

For cooling, the cooling medium is passed through the base channel at one end, with the base channel generally having radial channels which are directed in the direction of the conductors. First of all, the cooling medium flows through the base channel and then through the radial channels to the conductors to be cooled. As a result of a physical effect which is described by the so-called Bernoulli equation, the speed and the pressure of the cooling medium at the inlet of the base channel are different to the pressure and the speed of the cooling medium in the center of the rotor in the base channel. Branching into the radial channels is difficult at the rotor end, as a result of the high flow speed in the base channel. This results in the cooling medium being passed on poorly into the radial channels at the rotor end. In contrast, the cooling medium can be passed on relatively well into the radial channels at the generator center, since the flow speed at the rotor center is comparatively low. The cooling performance therefore differs in the axial direction. The rotor end is not cooled as well as the rotor center.

An object of the invention is to offer rotor cooling for an electrical machine, in which the rotor can be cooled uniformly in the axial direction.

This object is achieved by a rotor for a dynamoelectric machine with the rotor having a base channel with a base channel cross section for cooling of conductors which are arranged on the rotor, with the rotor being designed such that a cooling medium can flow through it during operation, with the base channel cross section being reduced.

The invention is based, inter alia, on the aspect that a cooling medium must be slowed down at those points where, according to the prior art, the flow speed is high. A high flow speed means that little cooling medium enters the radial channels. The invention is therefore based on the aspect that, according to the Bernoulli equation, the flow speed in the base channel can be reduced toward the rotor center by decreasing the base channel cross section toward the rotor center. The flow speed at the rotor end is thus decreased, as a result of which more cooling air can flow through the radial channels in the area of the rotor end. This unifies the flow speed of the cooling medium between the generator end and the generator center.

It is thus possible to lengthen the life of the electrical machine.

Advantageous developments are described in the dependent claims.

In one advantageous development, the rotor has radial cooling holes which are formed essentially at right angles to a rotation axis of the rotor. This provides the capability for the cooling medium to be passed on well, with the cooling medium flowing through the radial cooling holes being used to cool the conductors.

In one advantageous development, the radial cooling holes are connected for flow purposes to the base channel.

The base channel cross section is expediently designed such that it decreases significantly toward the rotor center. The flow speed, which can be described by the Bernoulli equation, is made uniform at the rotor end in comparison to the rotor center, by virtue of this expedient development, thus leading to better cooling of the conductor.

In a further advantageous development, the smallest cross section of the tapering base channel cross section is located essentially at the rotor center. It is thus possible to uniformly cool the rotor, which is essentially rotationally symmetrical and also has mirror-image symmetry toward the rotor center. The cooling at the rotor ends will accordingly not be subject to any major differences since the flow profiles and the pressure profiles from the two rotor end faces toward the rotor center are essentially the same.

In a further advantageous development, the base channel has straight boundary walls. This allows the base channel to be manufactured more easily. The costs for production of the rotor can accordingly be reduced.

In one advantageous development, at least one boundary wall of the base channel is non-linear. This makes it possible to vary the speed profile of the cooling medium by means of the non-linear profile of the boundary wall of the base channel, or to match it to the cooling requirements. For example, it may be desirable for the cooling medium to be fed at a very high speed at the rotor center. The speed of the cooling medium at the rotor center can expediently be varied by non-linear tapering of one boundary wall.

In a further advantageous development, the at least one boundary wall has a convex profile. The convex profile has the advantage that the boundary wall does not have any discontinuity, thus avoiding the appearance of any sudden speed changes occurring as a result of the flow. The convex profile nevertheless allows the speed of the cooling medium to be individually adapted. In this case, the boundary wall may have virtually any desired shape of a convex profile. For example, the boundary wall may represent part of a circular arc or may follow the profile of a parabola.

In a further advantageous development, the base channel has a base channel boundary base surface essentially parallel to the rotation axis.

In a further advantageous development, the base channel has a base channel boundary surface which is opposite the base channel boundary base surface and is arranged inclined with respect to the base channel boundary base surface. This means that a surface is formed parallel to the rotation axis, and the surface opposite this runs inclined thereto. It is thus possible to produce the rotor more quickly, and therefore at less cost.

In a further advantageous development, the base channel cross section located essentially at the rotor center has a size of between 30% and 50% of the size of the base channel cross section at the rotor end. Experimental investigations have shown that the reduction of the cross section of the base channel between these two values results in a particularly good cooling effect.

### BRIEF DESCRIPTION OF THE DRAWINGS

Exemplary embodiments of the invention will be described in the following text with reference to the drawing. The drawing is not intended to illustrate the exemplary embodiments to scale but in fact, where the drawing is used for explanatory purposes, it is in a schematic and/or slightly distorted form. With regard to additions to the teaching that is directly evident in the drawing, reference is made to the relevant prior art. In detail, in the drawing:

FIG. 1 shows a perspective illustration of a generator.

FIG. 2 shows a perspective illustration of a part of a rotor.

FIG. 3 shows a cross-sectional view of a rotor according to the prior art.

FIG. 4 shows a cross-sectional view of a rotor.

FIG. 5 shows an alternative embodiment of the rotor.

### DETAILED DESCRIPTION OF INVENTION

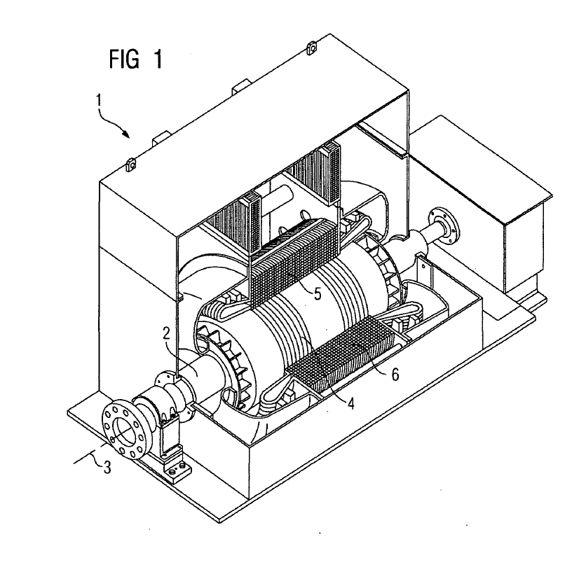

FIG. 1 shows a perspective illustration of a generator 1. The generator 1 should be considered to be an exemplary embodiment of a dynamoelectric machine. A further example of a dynamoelectric machine would be an electric motor. The generator 1 essentially comprises two components. A rotor 2 is arranged such that it can rotate about a rotation axis 3. The rotor 2 comprises a plurality of conductors 4 which are aligned in the axial direction. The electrical conductors 4 are connected to a field current by means of field current supply lines which are not shown in any more detail. This results in a magnetic field around the rotor 2. The rotor 2 is caused to rotate by steam or gas turbines, which are not illustrated. The rotation frequency is in this case generally 50 or 60 Hz.

A stator 5 is arranged around the rotor 2 and has a stator winding 6. The rotating magnetic field of the rotor 2 induces an electrical voltage in the stator winding 6, and this electrical voltage is then fed into a high-voltage power supply system. The electrical field currents flowing in the conductors 4 are comparatively high, as a result of which the heat which is developed in this way must be reduced by cooling.

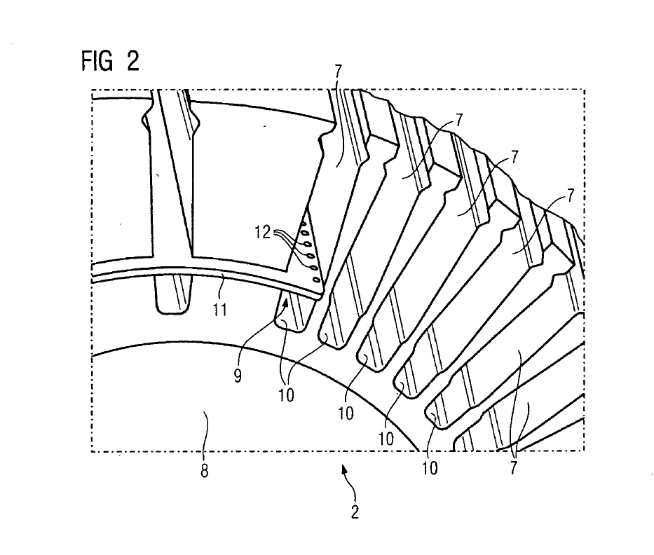

FIG. 2 shows a detail of the rotor 2, in the form of a perspective illustration. The rotor 2 comprises a plurality of slots 7 which are arranged alongside one another. Conductors which are not illustrated in any more detail in FIG. 2 are arranged in these slots, and the field current flows through these conductors. The slots 7 are elongated and generally have a constant cross section from the rotor end to the opposite rotor end face, although this cannot be seen in FIG. 2. The conductors 4 have the same width as the slots 7. The height of the conductors 4 is less than the height 16 of the slots 7. This results in a base channel 9 between the conductor 4 and a base channel boundary base surface 10.

A boundary means 11 is generally installed between the base channel boundary base surface 10 and a lower surface of the conductor 4. The boundary means 11 may be formed from copper. Radial channels 12 are formed in the boundary means 11. The radial channels 12 are connected for flow purposes to the base channel 9 and, so to speak, the object of the radial channels 12 is to pass a flow medium, which is flowing through the base channel 9, to the conductors 4 to be cooled. Depending on the required cooling performance, the number of radial channels 12 must be adapted.

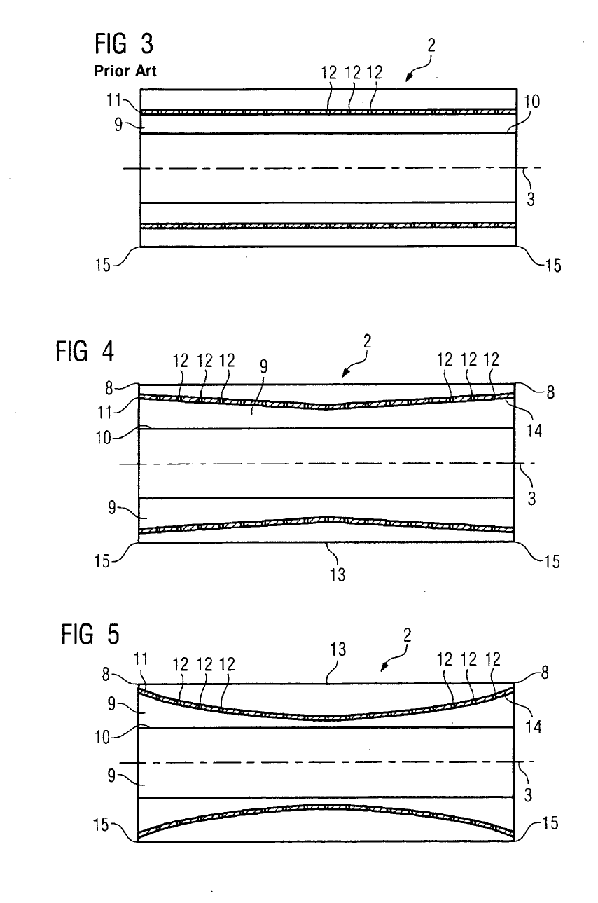

FIG. 3 shows a cross-sectional view of a rotor. The rotor shown in FIG. 3 is designed according to the prior art.

In this case, as is illustrated in FIG. 3, the base channel 9 is defined by the base channel boundary base surface 10 and the boundary means 11. During operation, a cooling medium, for example water or hydrogen, flows through the base channel 9. The boundary means 11 is in this case parallel to the base channel boundary base surface 10.

FIG. 4 shows a cross-sectional view of a rotor 2. The rotor shown in FIG. 4 has a base channel 9 which is designed for cooling of conductors 4 which are arranged on the rotor 2, in which case a cooling medium can flow through the cooling channel 9 during operation, with the base channel cross section decreasing. The cooling channel cross section in this case decreases from the end face 8 toward the rotor center 13. In this case, the rotor 2 has radial channels 12 which are essentially at right angles to a rotation axis 3 of the rotor 2.

The radial channels 12 are connected for flow purposes to the base channel 9.

The base channel cross section has the smallest cross section essentially at the rotor center 13. An embodiment of the base channel formed by straight boundary walls 14 and straight boundary means 11 is easy to produce from the manufacturing point of view.

FIG. 5 shows an alternative embodiment of a rotor 2 whose boundary wall 14 does not have a linear profile. In this case, the boundary wall 14 may have a convex profile. The base channel 9 may have a base channel boundary base surface 10 which is essentially parallel to the rotation axis 3. The base channel boundary surface 14 may be formed inclined with respect to the base channel boundary base surface 10. The base channel cross section at the rotor center has a size whose value is between 30% and 50% of the size of the base channel cross section at the rotor end 15.

1.-10. (canceled)

11. A rotor for a dynamoelectric machine, the rotor being designed such that a cooling medium flows through the rotor during operation, comprising:
conductors arranged in slots of the rotor;
a base channel having a base channel cross section for cooling the conductors, wherein the base channel cross section decreases;
a base channel boundary surface, the base channel being arranged between the conductors and the base channel boundary surface; and
a boundary provided between the base channel boundary surface and a lower surface of the conductors, wherein the base channel has straight boundary walls and the boundary is straight.

12. The rotor as claimed in claim 11, wherein the rotor has radial cooling holes formed essentially at right angles to a rotation axis of the rotor .

13. The rotor as claimed in claim 12, wherein the radial cooling holes are connected for flow purposes to the base channel.

14. The rotor as claimed in claim 11, wherein the base channel cross section decreases significantly toward the rotor centre.

15. The rotor as claimed in claim 12, wherein the base channel cross section decreases significantly toward the rotor centre.

16. The rotor as claimed in claim 14, wherein the base channel cross section essentially has the smallest cross section at the rotor centre.

17. The rotor as claimed in claim 15, wherein the base channel cross section essentially has the smallest cross section at the rotor centre.

18. The rotor as claimed in claim 11, wherein at least one boundary wall of the base channel is non-linear.

19. The rotor as claimed in claim 12, wherein at least one boundary wall of the base channel is non-linear.

20. The rotor as claimed in claim 14, wherein at least one boundary wall of the base channel is non-linear.

21. The rotor as claimed in claim 18, wherein at least one boundary wall has a convex profile.

22. The rotor as claimed in claim 19, wherein at least one boundary wall has a convex profile.

23. The rotor as claimed in claim 20, wherein at least one boundary wall has a convex profile.

24. The rotor as claimed in claim 12, wherein the base channel has a base channel boundary base surface which is essentially parallel to the rotation axis.

25. The rotor as claimed in claim 24, wherein the base channel has a base channel boundary surface which is opposite the base channel boundary base surface and is arranged obliquely with respect to the base channel boundary base surface.

26. The rotor as claimed in claim 11, wherein the base channel cross section located essentially at the rotor center has a size of between 30% and 50% of the size of the base channel cross section at the rotor end.
